(19) United States
(12) Patent Application Publication
(10) Pub. No.: US 2025/0351199 A1
(43) Pub. Date: Nov. 13, 2025

(54) TECHNIQUES FOR CODE DOMAIN MULTIPLEXING FOR IOT COMMUNICATION

(71) Applicant: Lenovo (Singapore) Pte. Ltd., New Tech Park (SG)

(72) Inventors: Ali Ramadan Ali, Kraiburg am Inn (DE); Karthikeyan Ganesan, Kronberg im Taunus (DE)

(21) Appl. No.: 18/660,130

(22) Filed: May 9, 2024

(51) Int. Cl. H04W 74/0833; G16Y 10/75; H04J 13/00

(52) U.S. Cl. CPC H04W 74/0858; H04J 13/0014; G16Y 10/75

(57) ABSTRACT

Various aspects of the present disclosure relate to transmitting a first random access configuration comprising code domain information and receiving a first set of random access transmissions from a set of internet-of-things (IoT) devices, each random access transmission of the first set of random access transmissions multiplexed according to the code domain information. Aspects of the present disclosure may relate to transmitting a second random access configuration to a subset of IoT devices of the set of IoT devices based at least in part on a collision between a subset of random access transmissions of the first set of random access transmissions, where the subset of random access transmissions is associated with the subset of IoT devices, and receiving a second set of random access transmissions based on the second random access configuration.

### TECHNICAL FIELD

The present disclosure relates to wireless communications, and more specifically to techniques for code domain multiplexing (also referred to as code-division multiple access) for internet-of-things (IoT) communication.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

Some implementations of the method and apparatuses described herein may transmit a first random access configuration comprising code domain information and receive a first set of random access transmissions from a set of internet-of-things (IoT) devices, where each random access transmission of the first set of random access transmissions is multiplexed according to the code domain information. Such implementations of the method and apparatuses described herein may also transmit a second random access configuration to a subset of IoT devices of the set of IoT devices based at least in part on a collision between a subset of random access transmissions of the first set of random access transmissions, where the subset of random access transmissions is associated with the subset of IoT devices, and receive a second set of random access transmissions based on the second random access configuration.

Some implementations of the method and apparatuses described herein may receive a random access configuration comprising code domain information, select a slot for random access based on the random access configuration, and select a sequence for random access based on the code domain information. Such implementations of the method and apparatuses described herein may also transmit a random access transmission during the selected slot and according to the selected sequence, where the random access transmission is multiplexed based on the selected sequence.

### BRIEF DESCRIPTION OF THE DRAWINGS

FIG. 1 illustrates an example of a wireless communications system in accordance with aspects of the present disclosure.

FIG. 2 illustrates an example of a protocol stack in accordance with aspects of the present disclosure.

FIG. 3A illustrates an example of a deployment scenario with direct communication between a network and an ambient IoT (AIoT) device, in accordance with aspects of the present disclosure.

FIG. 3B illustrates an example of a deployment scenario with indirect communication between a network and an AIoT device, in accordance with aspects of the present disclosure.

FIG. 4 illustrates an example of a radio protocol architecture for AIoT in accordance with aspects of the present disclosure.

FIG. 5 illustrates an example of an inventory procedure in accordance with aspects of the present disclosure.

FIG. 6 illustrates an example of duty cycle based operation of an AIoT device in an inventory round, in accordance with aspects of the present disclosure.

FIG. 7 illustrates an example of device multiplexing with both time division multiple access (TDMA) and code division multiple access (CDMA), in accordance with aspects of the present disclosure.

FIG. 8 illustrates an example of identifying code domain multiplexed sequences transmitted by multiple devices during the same time slot, in accordance with aspects of the present disclosure.

FIG. 9A illustrates an example of an IoT messaging procedure, in accordance with aspects of the present disclosure.

FIG. 9B is a continuation of the procedure of FIG. 9A.

FIG. 10 illustrates another example of an outage probability comparison, in accordance with aspects of the present disclosure.

FIG. 11 illustrates an example of a UE in accordance with aspects of the present disclosure.

FIG. 12 illustrates an example of a processor in accordance with aspects of the present disclosure.

FIG. 13 illustrates an example of a network equipment (NE) in accordance with aspects of the present disclosure.

FIG. 14 illustrates a flowchart of a method performed by a node in accordance with aspects of the present disclosure.

FIG. 15 illustrates a flowchart of a method performed by an IoT device in accordance with aspects of the present disclosure.

### DETAILED DESCRIPTION

Some wireless communication systems may deploy IoT devices. As used herein, an IoT device may refer to a device that may be equipped with one or more sensors, actuators, gadgets, appliances, or machines. The IoT device may be programmed for specific applications and may transmit data over the Internet or other networks. IoT use cases include—amongst others—inventory, sensor data collection, asset tracking, and actuator control.

Ambient Internet-of-Things (AIoT) refers to a new IoT technology suitable for deployment in a cellular telecommunication system. An AIoT device may be an ultra-low complexity device with ultra-low power consumption for very low-end IoT applications. Examples of such IoT applications include smart lighting, smart plugs, environmental monitoring, asset tracking, and the like. In various implementations, the energy of an AIoT device is provided through harvesting of radio waves, light, motion, heat, or any other suitable power source. Thus, an AIoT device may also be referred to as an “ambient power enabled” IoT device.

Some AIoT devices may lack (e.g., not equipped with) an energy storage component, as well as lack independent signal generation capability (e.g., backscattering transmission). Some other AIoT devices may be equipped with an energy storage component, but may lack independent signal generation capability (e.g., backscattering transmission). These AIoT devices may support the use of stored energy to amplify reflected signals. Other AIoT devices may be equipped with an energy storage component, as well as support independent signal generation (e.g., via an active radio frequency (RF) component).

In a wireless communication system, AIoT devices may be part of different topologies and deployment scenarios. For instance, a topology may include a base station (BS) that functions (e.g., operates) as a reader node and as a source of a carrier wave. Another topology may include a BS that functions (e.g., operates) as a reader node, but another device is used as a source of the carrier wave. Yet another topology may include a BS that functions (e.g., operates) as a controller and another intermediate node (such as a UE) that is used as the reader node and as a source of a carrier wave.

The slotted Aloha scheme has been agreed to be the main scheme of multiple access for AIoT. In the slotted Aloha scheme, time is divided into discrete slots, and each slot corresponds to a unit of transmission time. All communication attempts by users must align with these slots, therefore when a user has data to transmit, it waits for the beginning of the next time slot. The user transmits its data during the beginning of the time slot, however if two or more users attempt to transmit data at the same time slot, a collision occurs, and the data becomes corrupted. After a collision, the users involved typically wait for a random amount of time before attempting to retransmit their data to avoid another collision. This random waiting time helps reduce the probability of repeated collisions. However, the slotted Aloha scheme is inefficient with respect to the resource usage, and due to the presence of many IoT devices (e.g., including AIoT devices) that can attempt to access the network at the same time and hence this leads to collision and delayed access of many devices.

Various aspects of the present disclosure relate to configuring an IoT device with code domain information for improved multiplexing without requiring awareness at the device side for the device-to-reader (D2R) transmission. In some aspects of the present disclosure, each IoT device may select a circular-shifted binary modulated sequence from a base sequence. Transmission of the shifted base sequence allows for code-division multiplexing (CDM) of the random access transmissions, thereby reducing response time while also reducing the probability of a collision. Based on decoding the UL data following an identifier (e.g., a shifted sequence), a reader node may identify whether there was a collision during uplink (UL) transmission of circularly shifted sequence from multiple devices and may initiate a conflict resolution procedure in order to efficiently provide UL resources to an IoT device after the random access transmission. Aspects of the present disclosure are described in the context of a wireless communications system.

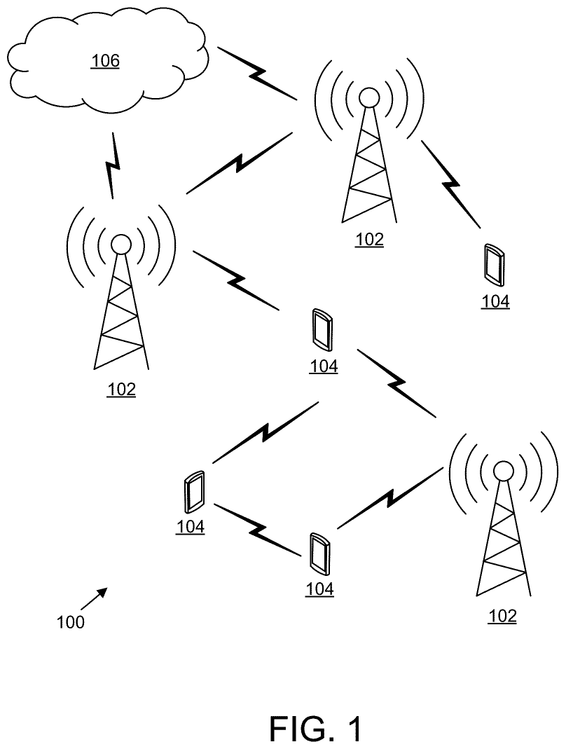

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as a Long-Term Evolution (LTE) network or an LTE-Advanced (LTE-A) network. In some other implementations, the wireless communications system 100 may be a New Radio (NR) network, such as a 5G network, a 5G-Advanced (5G-A) network, or a 5G ultrawideband (5G-UWB) network.

In other implementations, the wireless communications system 100 may be a combination of a 4G network and a 5G network, or other suitable radio access technology (RAT) including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as TDMA, frequency division multiple access (FDMA), or CDMA, etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an internet-of-things (IoT) device, an internet-of-everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N3, or network interface). In some implementations, the NE 102 may communicate with each other directly. In some other implementations, the NE 102 may communicate with each other indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management function (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signaling bearers, etc.) for the one or more UEs 104 served by the one or more NE 102 associated with the CN 106.

The CN 106 may communicate with a packet data network over one or more backhaul links (e.g., via an S1, N2, N3, or another network interface). The packet data network may include an application server. In some implementations, one or more UEs 104 may communicate with the application server. A UE 104 may establish a session (e.g., a protocol data unit (PDU) session, or a PDN connection, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively.

Each slot may include a number (e.g., quantity) of symbols (e.g., orthogonal frequency domain multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHZ-24.25 GHZ), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

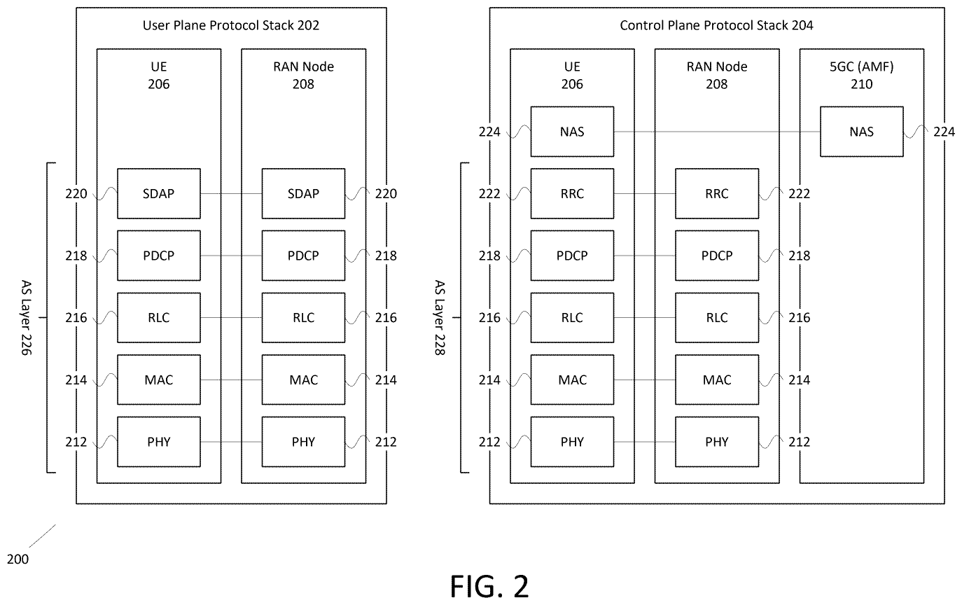

FIG. 2 illustrates an example of a protocol stack 200, in accordance with aspects of the present disclosure. While FIG. 2 shows a UE 206, a RAN node 208, and a 5G core network (5GC) 210 (e.g., comprising at least an AMF), these are representative of a set of UEs 104 interacting with an NE 102 (e.g., base station) and a CN 106. As depicted, the protocol stack 200 comprises a user plane protocol stack 202 and a control plane protocol stack 204. The user plane protocol stack 202 includes a physical (PHY) layer 212, a medium access control (MAC) sublayer 214, a radio link control (RLC) sublayer 216, a packet data convergence protocol (PDCP) sublayer 218, and a service data adaptation protocol (SDAP) sublayer 220. The control plane protocol stack 204 includes a PHY layer 212, a MAC sublayer 214, a RLC sublayer 216, and a PDCP sublayer 218. The control plane protocol stack 204 also includes a radio resource control (RRC) layer 222 and a non-access stratum (NAS) layer 224.

The access stratum (AS) layer 226 (also referred to as “AS protocol stack”) for the user plane protocol stack 202 consists of at least SDAP, PDCP, RLC and MAC sublayers, and the physical layer. The AS layer 228 for the control plane protocol stack 204 consists of at least RRC, PDCP, RLC and MAC sublayers, and the physical layer. The layer-1 (L1) includes the PHY layer 212. The layer-2 (L2) is split into the SDAP sublayer 220, PDCP sublayer 218, RLC sublayer 216, and MAC sublayer 214. The layer-3 (L3) includes the RRC layer 222 and the NAS layer 224 for the control plane and includes, e.g., an internet protocol (IP) layer and/or PDU Layer (not depicted) for the user plane. L1 and L2 are referred to as “lower layers,” while L3 and above (e.g., transport layer, application layer) are referred to as “higher layers” or “upper layers.”

The PHY layer 212 offers transport channels to the MAC sublayer 214. The PHY layer 212 may perform a beam failure detection procedure using energy detection thresholds, as described herein. In certain embodiments, the PHY layer 212 may send an indication of beam failure to a MAC entity at the MAC sublayer 214. The MAC sublayer 214 offers logical channels to the RLC sublayer 216. The RLC sublayer 216 offers RLC channels to the PDCP sublayer 218. The PDCP sublayer 218 offers radio bearers to the SDAP sublayer 220 and/or RRC layer 222. The SDAP sublayer 220 offers QoS flows to the core network (e.g., 5GC). The RRC layer 222 manages the addition, modification, and release of carrier aggregation and/or dual connectivity. The RRC layer 222 also manages the establishment, configuration, maintenance, and release of signaling radio bearers (SRBs) and data radio bearers (DRBs).

The NAS layer 224 is between the UE 206 and an AMF in the 5GC 210. NAS messages are passed transparently through the RAN. The NAS layer 224 is used to manage the establishment of communication sessions and for maintaining continuous communications with the UE 206 as it moves between different cells of the RAN. In contrast, the AS layers 226 and 228 are between the UE 206 and the RAN (i.e., RAN node 208) and carry information over the wireless portion of the network. While not depicted in FIG. 2, the IP layer exists above the NAS layer 224, a transport layer exists above the IP layer, and an application layer exists above the transport layer.

The MAC sublayer 214 is the lowest sublayer in the L2 architecture of the NR protocol stack. Its connection to the PHY layer 212 below is through transport channels, and the connection to the RLC sublayer 216 above is through logical channels. The MAC sublayer 214 therefore performs multiplexing and demultiplexing between logical channels and transport channels: the MAC sublayer 214 in the transmitting side constructs MAC PDUs (also known as transport blocks (TBs)) from MAC service data units (SDUs) received through logical channels, and the MAC sublayer 214 in the receiving side recovers MAC SDUs from MAC PDUs received through transport channels.

In the radio protocol architectures described herein, the term “SDU” refers to a data unit that is received by a sublayer from a higher sublayer, or that is sent by a sublayer to a higher sublayer. Likewise, the term “PDU” refers to a data unit that is sent by a sublayer to a lower sublayer, or that is received by a sublayer from a lower sublayer.

The MAC sublayer 214 provides a data transfer service for the RLC sublayer 216 through logical channels, which are either control logical channels which carry control data (e.g., RRC signaling) or traffic logical channels which carry user plane data. On the other hand, the data from the MAC sublayer 214 is exchanged with the PHY layer 212 through transport channels, which are classified as UL or downlink (DL). Data is multiplexed into transport channels depending on how it is transmitted over the air.

The PHY layer 212 is responsible for the actual transmission of data and control information via the air interface, i.e., the PHY layer 212 carries all information from the MAC transport channels over the air interface on the transmission side. Some of the important functions performed by the PHY layer 212 include coding and modulation, link adaptation (e.g., adaptive modulation and coding (AMC)), power control, cell search and random access (for initial synchronization and handover purposes) and other measurements (inside the Third Generation Partnership Project (3GPP) system (i.e., NR and/or LTE system) and between systems) for the RRC layer 222. The PHY layer 212 performs transmissions based on transmission parameters, such as the modulation scheme, the coding rate (i.e., the modulation and coding scheme (MCS)), the number of physical resource blocks (PRBs), etc.

In some embodiments, the protocol stack 200 may be an NR protocol stack used in a 5G NR system. Note that an LTE protocol stack comprises similar structure to the protocol stack 200, with the differences that the LTE protocol stack lacks the SDAP sublayer 220 in the AS layer 226, that an EPC replaces the 5GC 210, and that the NAS layer 224 is between the UE 206 and an MME in the EPC. Also note that the present disclosure distinguishes between a protocol layer (such as the aforementioned PHY layer 212, MAC sublayer 214, RLC sublayer 216, PDCP sublayer 218, SDAP sublayer 220, RRC layer 222 and NAS layer 224) and a transmission layer in multiple-input multiple-output (MIMO) communication (also referred to as a “MIMO layer” or a “data stream”).

IoT has attracted much attention in the wireless communication world. More ‘things’ are expected to be interconnected for improving productivity efficiency and increasing comforts of life. Further reduction of size, complexity, and power consumption of IoT devices can enable the deployment of tens or even hundreds of billion IoT devices for various applications and provide added value across the entire value chain.

Most of the existing wireless communication devices are powered by batteries that need to be replaced or recharged manually. However, relying on battery power for IoT devices can be problematic as the batteries may require replacement or recharging manually, which leads to high maintenance cost, environmental issues, and even safety hazards for some use cases (e.g., wireless sensor in electric power and petroleum industry).

Ambient power enabled IoT devices (i.e., AIoT devices) are being studied to resolve the above problems with battery powered IoT devices. AIoT devices that consume very low power and rely on harvesting the energy are being studied and may include either battery-less devices or devices with limited energy storage capability (i.e., using a capacitor) and the energy is provided through the harvesting of radio waves, light, motion, heat, or any other suitable power source. Some high-level agreements have been achieved regarding AIoT, e.g., on the transmission of carrier wave in and out of the agreed topologies, as well as some high-level design of DL and UL channels.

Considering the limited size and complexity required by practical applications for battery-less devices with no energy storage capability or devices with limited energy storage that do not need to be replaced or recharged manually, the output power of an energy harvester is typically from 1 μW to a few hundreds of ηW. Existing cellular devices may not work well with energy harvesting due to their peak power consumption of higher than 10 mW.

An example type of application in 3GPP technical report (TR) 22.840 is asset identification, which presently has to resort mainly to barcode and radio frequency identification (RFID) in most industries. The main advantage of these two technologies is the ultra-low complexity and small form factor of the tags. However, the limited reading range of a few meters usually requires handheld scanning which leads to labor intensive and time-consuming operations, or RFID portals/gates which leads to costly deployments. Moreover, the lack of interference management scheme results in severe interference between RFID readers and capacity problems, especially in case of dense deployment. It is hard to support large-scale networks with seamless coverage for RFID.

Since existing technologies cannot meet all the requirements of target use cases, a new IoT technology is recommended to open new markets within 3GPP systems, whose number of connections and/or device density can be orders of magnitude higher than existing 3GPP IoT technologies. The new IoT technology shall provide complexity and power consumption orders of magnitude lower than the existing 3GPP low power wide area (LPWA) technologies (e.g., narrowband IoT (NB-IoT) and eMTC) and shall address use cases and scenarios that cannot otherwise be fulfilled based on existing 3GPP LPWA IoT technologies.

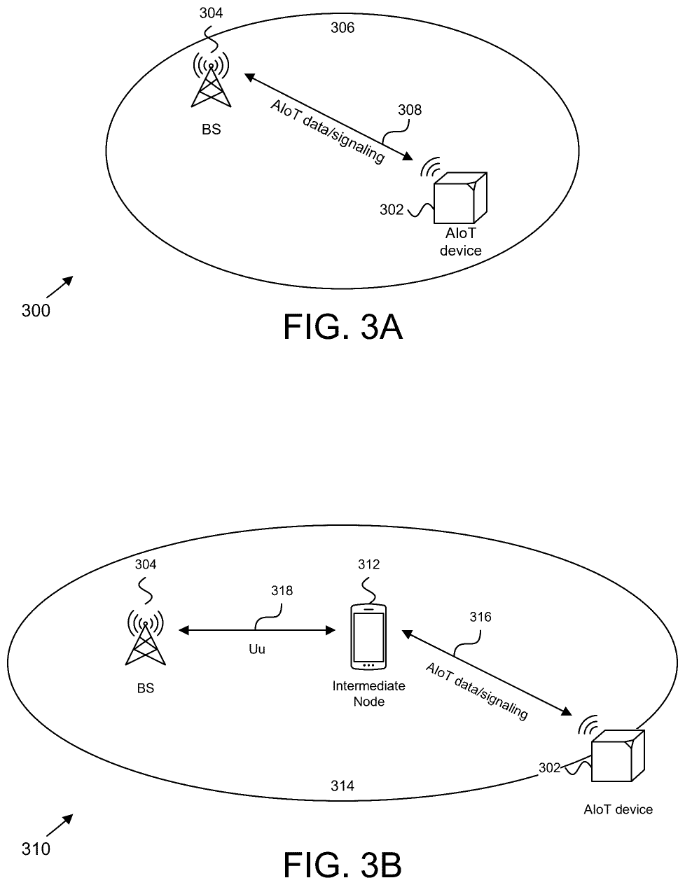

FIG. 3A depicts an exemplary network topology 300 of a first deployment scenario in accordance with aspects of the present disclosure. In the exemplary network topology 300, an AIoT device 302 may communicate directly and bidirectionally (e.g., receive, transmit) with a BS 304 via communication link 308. The BS 304 may serve a geographic coverage area, such as a micro cell 306. The communication link 308 between the BS 304 and the AIoT device 302 may be, for example, for transferring (e.g., transmitting, receiving, forwarding, routing, reflecting) AIoT data and/or signaling. In one embodiment, both the BS 304 and the AIoT device 302 may be located indoors. The BS 304 may be co-sited with one or more RAN nodes of other cellular technologies (e.g., 3GPP technologies).

FIG. 3B depicts an exemplary network topology 310 of a second deployment scenario in accordance with aspects of the present disclosure. In the exemplary network topology 310, an AIoT device 302 may communicate bidirectionally (e.g., receive, transmit) with an intermediate node 312 (e.g., a UE), which may be between the AIoT device 302 and the BS 304. The BS 304 may serve a macro cell 314. For example, the AIoT device 302 may communicate (e.g., transmit, receive, forward) AIoT data and/or signaling via a communication link 316 between the AIoT device 302 and the intermediate node 312. Additionally, the intermediate node 312 may communicate (e.g., transmit, receive, forward, relay) the AIoT data and/or signaling via a communication link 318 between the intermediate node 312 and the BS 304. The intermediate node 312 may be a relay device located between the AIoT device 302 and the BS 304. The intermediate node 312 may be a UE as described herein with reference to FIG. 1, and may be located in the same environment (e.g., indoors) as the AIoT device 302.

In one embodiment, the intermediate node 312 may function (e.g., operate) as a relay node between the BS 304 and the AIoT device 302. In another embodiment, the intermediate node 312 may function as an interrogator (e.g., reader) between the BS 304 and the AIoT device 302, where the intermediate node 312 receives a service request from an AIoT client (e.g., an inventory client) and initiates an AIoT service procedure with the AIoT device 302 in response to the request. In some embodiments, the BS 304 may be located outdoors, while both the intermediate node 312 and the AIoT device 302 may be located indoors. The BS 304 may be co-sited with one or more RAN nodes of other cellular and/or non-cellular technologies.

Decoding a backscattered signal at the BS 304 (or the intermediate node 312) may be based on various factors, such as a distance between the AIoT device 302 and the BS 304 (or the intermediate node 312), a transmit power and/or a distance between a carrier wave emitter (e.g., a reader or a separate emitter) or the intermediate node 312 and the AIoT device 302, a channel for both links, one or more hardware characteristics of the AIoT device 302 including different types of losses within circuitry of the AIoT device 302, as well as other factors such as modulation and coding schemes (MCS) for modulating and encoding the backscattered signal, or a combination thereof. For the AIoT device 302, the quality of a backscattering signal may vary according to the distance, channel conditions, blockages, or a combination thereof.

Considering the fact that AIoT devices are assumed to be ultra-low complexity devices with ultra-low power consumption for the very low-end IoT applications, the radio protocol architecture for AIoT needs to be compact compared to the architecture as specified for NR.

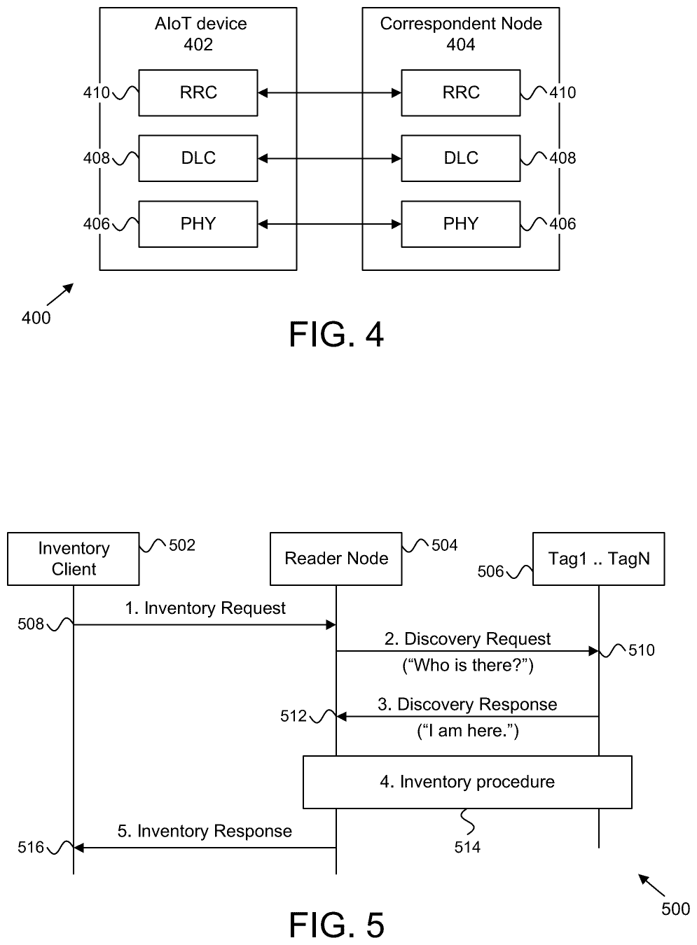

FIG. 4 illustrates an example of a protocol stack 400 for the AIoT control plane radio protocol architecture, in accordance with aspects of the present disclosure. While FIG. 4 shows an AIoT UE 402 and correspondent node 404 (e.g., a base station or intermediate node), these are representative of a set of AIoT UEs 104 interacting with an interrogator (e.g., an embodiment of the NE 102 and/or the UE 104). As depicted, the protocol stack 400 includes a PHY layer 406, a data link control (DLC) layer 408, and a RRC layer 410. In certain embodiments, the protocol stack 400 may include the PHY layer 406, the DLC layer 408, and the RRC layer 410.

One or more functions of the RRC layer 410 may include broadcasting of system information, paging, RRC connection control, and AS security. One or more functions of the DLC layer 408 may include transfer of data (i.e., user plane and/or control plane), ciphering, integrity protection, multiplexing of MAC SDUs belonging to one or different logical channels into TBs delivered to PHY layer 406. One or more functions of the PHY layer 406 may include the channel coding, error detection, modulation, frequency and time synchronization, and measurements.

FIG. 5 shows an exemplary message flow for an inventory procedure 500, in accordance with aspects of the present disclosure. Inventory is one example use case for AIoT, and the inventory procedure 500 may involve an inventory client 502, a reader node 504, and a plurality of tags 506, wherein each tag 506 is realized as an AIoT device.

It is assumed that the inventory client 502 wants to take inventory of all the items which are located in a certain area, e.g., a warehouse. In certain embodiments, each item is attached with a tag 506 (acting as transponder) or is otherwise associated with an AIoT device. The inventory client may be a UE or network function (NF) within the network, or a third-party entity attached to the network. The reader node 504 (also known as an interrogator) may be part of the network consisting of CN and RAN, and may be a BS itself. Alternatively, the reader node 504 may be an intermediate node, such as a UE.

At step 1, the inventory client 502 may transmit, to the reader node 504, an inventory request message to collect a set of one or more electronic product codes of each of the one or more tags 506 (i.e., Tag1, . . . , Tag N) that may be located in an area (e.g., environment, location, zone, etc.) (see signaling 508).

At step 2, the reader node 504 may transmit, to each of the one or more tags 506, a discovery request message (see signaling 510). For example, the reader node 504 may transmit, to each of the one or more tags 506, in the area the discovery request message.

At step 3, each of the one or more tags 506 may transmit a discovery response message to the reader node 504 (see signaling 512). For example, each of the one or more tags 506 that received the discovery request message from the reader node 504 may transmit the discovery response message to the reader node 504.

At step 4, the reader node 504 and each of the one or more tags 506 may perform an inventory procedure (see block 514). That is, the reader node 504 may perform the inventory procedure with each of the one or more discovered tags 506. During the inventory procedure the reader node 504 may collect a corresponding electronic product code from each of the one or more discovered tags 506 (i.e., Tag1, . . . , Tag N).

At step 5, the reader node 504 may transmit an inventory response message to the inventory client 502 (see signaling 516). The inventory response message may include the collected electronic product codes (i.e., received from each of the one or more discovered tags 506).

In some cases, at the beginning of the inventory process, it might not be possible to assume that every AIoT device is fully charged and able to endure an entire inventory round with the stored energy. Accordingly, the AIoT device might need to harvest energy to sustain operation (e.g., transmission, reception) within the inventory round. Also, the AIoT device might have to harvest energy to sustain the operation (e.g., receiving) outside the inventory round, for example, to regularly monitor for an inventory request command from the reader node 504. Because energy harvesting is an integral part of the AIoT device functionality, in some embodiments a minimum capacitance size and a threshold (e.g., minimum) resistance for harvesting may be defined.

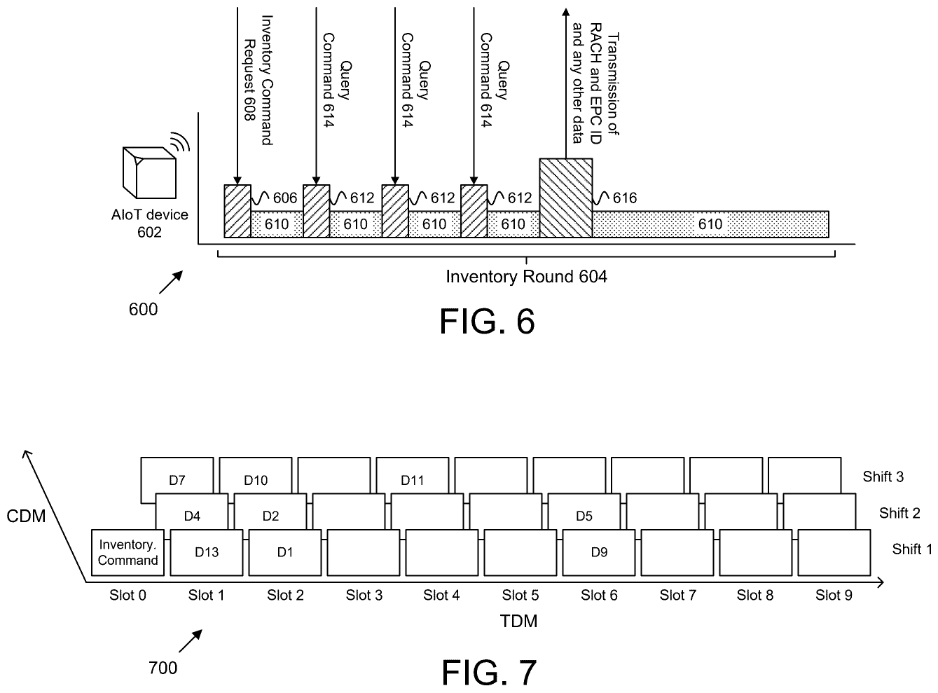

FIG. 6 illustrates one example of a duty cycle based operation 600 of an AIoT device 602 in an inventory round 604, in accordance with aspects of the present disclosure. The inventory round 604 may be implemented as part of the inventory procedure. During a receive time 606 (e.g., an active/awake time), the AIoT device 602 may receive an inventory command request 608, which initiates the inventory round 604. The AIoT device 602 may also return to a sleep/harvesting state after reception of the inventory command request 608, represented as sleep/harvesting time 610.

During subsequent receive times 612 (e.g., subsequent active/awake times), the AIoT device 602 may receive one or more Query commands 614. Responsive to the Query command 614, during an awake time 616 the AIoT device 602 may perform a random access procedure (RACH procedure) and transmits a RACH request and an identity (ID), such as an EPC ID. Note that generating and transmitting messages may consume more power at the AIoT device 602 than receiving and processing messages. The AIoT device 602 may receive UL resources (or D2R resources) during the awake time 616 and additionally transmit other data related to the inventory command request 608.

Accordingly, the AIoT device 602 may periodically wake up from a sleep/harvesting time 610 to monitor for the Query command 614 within the inventory round 604 and once the inventory of the AIoT device 602 is finished (e.g., after transmitting the RACH message, ID and other data), the AIoT device 602 may sleep until the end of the inventory round 604. In certain embodiments, the AIoT device 602 may adjust its duty cycle to wake up more often during the inventory round 604.

Hence, the power consumption of the AIoT device 602 may take into consideration the periodic receptions and synchronization associated with the inventory round 604. The power consumption of transmitting the RACH message and the EPC ID by the AIoT device 602 also may be taken into consideration within the inventory round 604. The AIoT device 602 may need to maintain minimum power consumption within the inventory round 604 for maintaining the RAM memory.

The successful inventory completion time of the AIoT devices is defined as the probability of z % AIoT devices to receive the inventory command, periodic query command and transmit the EPC ID within the inventory latency budget. The non-availability of enough energy from the capacitor to sustainably operate an AIoT device 602 within an inventory round 604 may lead to AIoT device outage. Such outage probability considering the non-availability of energy to transmit the EPC ID within an inventory round of X devices may affect the successful inventory completion time.

Time domain multiple access schemes, such as the slotted Aloha scheme, may aid in resolving the initial responses from multiple devices attempting to access the channel by randomly selecting a time slot by each device for UL transmission. However, as the number of devices increases, the probability of selecting the same slot by multiple devices also increases and hence the chance of collision increases.

To reduce the collision between devices attempting to access the network at the same time, i.e., choosing the same slot for responding to a reader command, such as an inventory command, and to reduce the time of an inventory round, a code domain multiple access scheme may be applied on the devices' responses. The responses of AIoT devices may be code-division multiplexed (CDMed) at the reader side without any awareness at the device side for the D2R transmission.

In accordance with aspects of a first solution, multiple IT may be grouped in the same resource occasion for the D2R transmission of the RACH message using a CDM approach. In such embodiments, each of the IoT device may select a circularly shifted binary modulated sequence from a base sequence, such as a binary or Golay sequence, for D2R transmission. The reader node may detect the circularly shifted sequence using the correlated peaks and may report the detected circularly shifted value to the IoT devices as part of a device identification step. An IoT device may select one of the circularly shifted values from the discrete set of circularly shifted range provide to the AIoT devices in a groupcast message, such as inventory command or other reader-to-device (R2D) transmission.

To support the code domain multiple access of a plurality of IoT devices (e.g., AIoT devices), the reader node (e.g., a BS) may send (transmit) to a plurality of IoT devices a first random access configuration for initial access, e.g., during an inventory procedure. To support time domain multiple access, the first random access configuration indicates a set of slots for transmitting an inventory response to the reader node. To support the code domain multiple aspect, the first random access configuration may also contain an indication of a base sequence to be used for initial access procedure by the plurality of IoT devices.

In one implementation, one or more base sequences may be preconfigured, e.g., stored in the IoT device's memory and the reader node may send (e.g., in the first random access configuration) an indication of which base sequence to be used. In another implementation, a base sequence with a certain length may be signaled to the plurality of IoT devices during the inventory period. For example, the inventory command request may include code domain information, such as the base sequence. In further embodiments, the first random access configuration may configure the one or more base sequences.

In certain embodiments, the location of the sequence, e.g., within the physical reader-to-device channel (PRDCH), may be preconfigured or otherwise known to the IoT device. In other embodiments, the location of the sequence, within the PRDCH, may be signaled to the IoT device, e.g., indicated in a control channel or included in a configuration sent to the IoT device, such as the first random access configuration.

In embodiments of the first solution, the first random access configuration may further contain information about a set of integer values or ranges to be selected and applied by the device as part of a circular shift spacing on the base sequence for creating orthogonal codes. For example, the information may include an integer factor of gap/circular shift spacing value for sequence spacing between different circular shifts of the base sequence. A gap value, as used herein refers to a circular shift sequence spacing between permissible circular shifts of the base sequence and there may be integer factor of such circular shift spacing provided by the reader node and a respective AIoT device randomly selects one among them.

To improve cross correlation, certain possible circular shifts may be forbidden thereby resulting in a gap between candidate circular shifts of the base sequence. The gap between two different circular shifts may allow for better resolution of the peaks that appear in the cross-correlation. Otherwise, due to channel/noise and the used sampling frequency the peaks may be close to each other and hard to resolve.

The gap may depend on the number of expected devices accessing the channel and length of the sequence as increasing the gap reduces the possible number of multiplexed devices. The gap between two circular shifts may also be referred to as the “circular shift spacing” as the gap value is an integer factor determining the spacing between circular shifts, wherein the IoT device will select an integer factor of the circular shift spacing between permissible circular shifts of the base sequence.

As used herein, a circular shift of a sequence refers to an operation that involves shifting all the elements of the sequence to the right or left by a certain number of positions, with the elements that “fall off” at one end being reinserted at the opposite end. For example, if a base sequence of 5 elements [n1 n2 n3 n4 n5] is circularly shifted to the right by 2 positions, then the resulting shifted sequence would be [n4 n5 n1 n2 n3]. This circular shift operation may also be referred to as a “cyclic shift” or a “rotation” of the base sequence.

In embodiments of the first solution, the first random access configuration may further contain information about a minimum shift (i.e., threshold shift) of the base sequence that may be selected. In certain embodiments, the minimum shift may be a minimum offset from the base sequence.

In various embodiments, the reader node may signal a set of integer values (or a set of integer ranges) of circular shifts for the devices. A respective IoT device may then select one of the values for the circular shift from the signaled set of value (or ranges). The base sequence and its circularly shifted versions need to have good orthogonality and good correlation property so that the reader node can resolve multiple devices transmitting at the same time/frequency resources.

Upon receiving the gap value or the circularly shifted value from the set of circularly shifted range, and in addition to selecting a random slot for transmitting the inventory response to the reader node, the IoT device may apply a random circular shift on the base sequence with an integer factor which is a multiple of the indicated gap, e.g., 0×gap, 1×gap, 2×gap, 3×gap, etc. In various embodiments, one or more IoT devices may select the same time slot but with different circular shifts of the base sequence.

The IoT device may backscatter or transmit a UL response (also referred to as a D2R response) during the selected time slot that contains the randomly selected circularly shifted sequence from the selected set of ranges. The dynamic range for selecting the circular shifts may depend on the length of the sequence and the indicated gap (e.g., circular shift spacing).

In one implementation, the base sequence (or circularly shifted sequence) may contain 0s and 1s, such that the sequence may form a binary modulated sequence for allowing passive devices (e.g., AIoT devices that lack independent signal generation or lack the capacity to amplify reflected signals) to apply the circularly shifted version of the sequence using on-off keying (OOK) modulation on top of the carrier wave.

In another implementation, the base sequence (or circularly shifted sequence) may contain 1s and −1s, such that the sequence may form a complementary binary modulated sequence (e.g., a Golay sequence) which may be shifted in base band by active devices (e.g., AIoT devices that have independent signal generation and/or have the capacity to amplify reflected signals).

In various embodiments, the reader node may transmit a periodic random access round trigger within an inventory round, where the periodic random access round trigger may indicate the set of ranges of circular shift values (e.g., the set of range values [10-20, 20-30, 40-50]) and the number of IoT devices selected in a subpopulation (e.g., by using the masking of EPC bits in a subgroups or groups). In certain embodiments, the range of values may be chosen according to IoT devices' tolerance to the maximum timing errors. Within an inventory round, the reader node may periodically transmit a random-access channel (RACH) occasion trigger for selecting a subpopulation of IoT devices (e.g., tags) for inventorying or allowing a sub-selected tag to perform a RACH transmission. Each such trigger can contain the same circular shift spacing or different circular shift spacing (i.e., integer factors of the circular shift spacing).

FIG. 7 illustrates an exemplary resource grid 700 for device multiplexing with both TDMA and CDMA, in accordance with aspects of the present disclosure. The resource grid 700 shows both time domain resources and code domain resources. A node (e.g., reader) may transmit an inventory command in slot 0 and then await response messages from one or more IoT devices. In the depicted embodiment, response messages may be sent by 9 IoT devices, denoted D1, D2, D4, D5, D7, D9, D10, D11, and D13.

As described above, upon receiving the inventory command, a respective IoT device may randomly select a time slot and also randomly select a circular shift value. In the depicted in FIG. 7, the time slot is selected from slot 1, slot 2, slot 3, slot 4, slot 5, slot 6, slot 7, slot 8, or slot 9 and the circular shift value is selected from shift 1, shift 2, or shift 3. Using the selected time slot and circular shift value, a respective IoT device may respond to the inventory command by sending a response message embodying the shifted sequence corresponding to the selected circular shift value. The response message may embody an initial D2R transmission from the respective IoT device.

Using both TDMA and CDMA reduces the likelihood of collision of the response messages. As depicted in FIG. 7, multiple IoT devices may randomly select the same time slot or randomly select the same circular shift; however, there are no collisions in the depicted embodiment and the node is able to receive the response messages. Note that a node may be referred to as a network node or a wireless node, which may be a network entity, a base station, or a UE as described herein.

Upon receiving the CDMed sequences from multiple IoT devices in a certain time slot, the node (e.g., reader) may perform cross correlation between the base sequence and the received signal that are circular shifted, thereby identifying the number of CDMed sequences as well as the shifts each IoT device applied on the base sequence. In the example of FIG. 7, three devices (D4, D7, and D13) chose the same time slot and randomly selected different circular shifts of the base sequence from different range of circular shifts for their UL transmission such as random access. The cross-correlation at the node detects three peaks representing the three devices, each applying a different discrete circular shift (e.g., each signal modulated with a different circular shift of the base sequence).

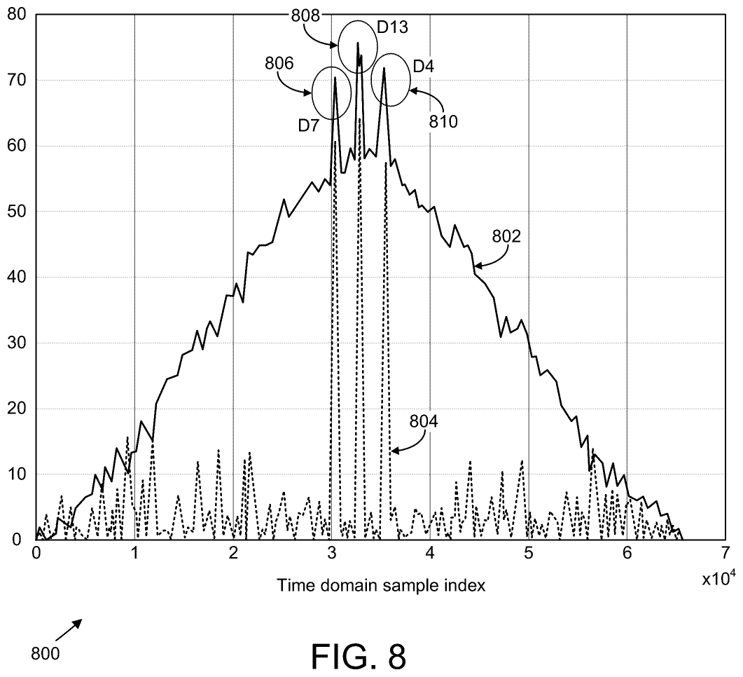

FIG. 8 illustrates an exemplary cross-correlation diagram 800 identifying CDMed sequences transmitted by three IoT devices during the same time slot, in accordance with aspects of the present disclosure. The diagram 800 assumes the transmissions in slot 1 depicted in FIG. 7 and described above. The diagram 800 includes a first cross-correlation result 802 derived from a binary modulated sequence containing 0s and 1s. The diagram 800 also includes a second cross-correlation result 804 derived from a complementary binary modulated sequence (e.g., Golay sequence) containing 1s and −1s. As shown, the complementary binary modulated sequence (e.g., Golay sequence) containing 1s and −1s has better cross-correlation performance than the binary modulated sequence containing 0s and 1s. However, the binary modulated sequence containing 0s and 1s is supported by more device types.

The first cross-correlation result 802 and the second cross correlation result 804 are examples of the cross-correlation performed at reader node between the base signal and the received signal (i.e., mixed, shifted multiple versions of the base sequence). The Y-axis of the diagram 800 is the magnitude of the cross correlation, where the value depends on the magnitude of each signal and length of the signals. The X-axis of the diagram 800 is an index representing the time domain samples of the output cross-correlation, where each index represents one sample shift. Where there is an orthogonality/circular shift relation between one of the signals in the mixed received signal and the base signal, the magnitude of the correlation will be high at the shift between these two signals (i.e., the base signal and the shifted signal).

As depicted in FIG. 8, the cross-correlation results 802 and 804 may indicate three peaks which correspond to a respective transmission of a circularly shifted sequence by a respective IoT device. Specifically, the cross-correlation results 802 and 804 may indicate a first peak 806 corresponding to a transmission by device D7, a second peak 808 corresponding to a transmission by device D13, and a third peak 810 corresponding to a transmission by device D4. Accordingly, the node (e.g., reader) may detect the three peaks representing the transmissions by the three devices, each modulating the D2R signal using (i.e., applying) a different discrete circular shift.

In various embodiments, for facilitating the initial access, the reader may send a reply message to the IoT devices after performing the cross-correlation and identifying the devices. In one example, the reply message may carry (e.g., contain) the IoT device's selected shifted sequence and/or the detected circular shift value for contention resolution, e.g., as part of the R2D preamble of the reply message. In another example, the reply message may carry (e.g., contain) the detected shifted sequence or an indication of the shifted sequence, such as the detected shift value, e.g., as part of a R2D control channel transmission or the R2D payload of the reply message.

In one implementation, the reader-identified shifted sequence (i.e., as selected by a particular IoT device) may be used as an identifier for further communication between the reader node and the particular IoT device for both UL (e.g., D2R) and DL (e.g., R2D) communications. In another implementation, a new identifier may be sent to the IoT device identified by the shifted sequence (e.g., an already inventoried device) for further communication.

In various embodiments, upon receiving the reply message, a respective IoT device may send its UL data at the configured time slot in an D2R transmission. In certain embodiments, for each transmission the IoT device may include its selected circular shift in the UL signal (e.g., D2R transmission), e.g., prior or after the UL preamble as an identifier of the device.

According to aspects of a second solution, the reader node may perform collision detection and collision handling for CDMed transmission from IoT devices. In some embodiments, the reader node may identify whether there was a collision or not during UL transmission of circularly shifted sequence from multiple devices based on decoding the UL data following the identifier. For example, if two or more IoT devices randomly selected the same circular shift at the same time and frequency, then the reader node would identify a single shift in the outcome of the cross correlation but would not be able to distinguish, from this initial D2R transmission, whether a single device or multiple devices transmitted the shifted sequence, and hence a single device may be assumed by the reader node.

As described above, the reader node may send a reply message based on the time slot and the identified shifted sequence, and the IoT device associated with the time slot and the shifted sequence transmits its data. However, when two or more IoT devices randomly selected the same circular shift at the same time and frequency, the two or more IoT devices will respond to the same reply message (R2D transmission) since they chose same circular shift at the same time and frequency.

As described above, when responding to the received reply message, a respective IoT device may transmit the identifier followed by data corresponding to the inventory command. In certain embodiments, the identifier may be unique (e.g., locally unique or globally unique) to each IoT device, therefore revealing a collision due to not correctly decoding the identifier. In other embodiments, the identifier is the shifted sequence (or shifted sequence value) previously selected by the IoT device wherein the identifier itself will not reveal the collision. Moreover, the data following the identifier in the D2R transmission will most likely be different for different devices, therefore upon not correctly decoding the data (e.g., upon receiving undecodable data), the reader node may identify that either the UL channel (or D2R channel) is bad or that there is a collision due to more than one device with the same identifier.

Upon not correctly decoding the D2R message, the reader node may send (e.g., transmit) an indication to the collided devices (i.e., using collided circular shift as an identifier) for choosing (i.e., selecting at random) other circular shifts. In certain embodiments, the reader node may send (e.g., transmit) a second random access configuration (e.g., using groupcast transmission) to the collided devices (i.e., to all IoT devices that used the same circular shift at the same time and frequency), wherein the second random access configuration is (or includes) the indication to select another circular shift and retransmit the response message.

In one implementation, the same gap value (e.g., circular shift spacing) and base sequence may be used at the IoT device side when retransmitting the response message. In another implementation, the reader node may indicate a different gap value and/or a different base sequence to use for the circular shifts for the retransmission of the response message. For example, the second random access configuration may indicate the different gap value and/or the different base sequence for the retransmission of the response message. In yet another implementation, the reader node may indicate that a simplified procedure is to be used for the retransmission of the response message, wherein CDM is switched off for the retransmission and the collided devices use a TDMA approach. In such embodiments, TDMA collisions are less likely to occur as only the collided devices need to retransmit the response message.

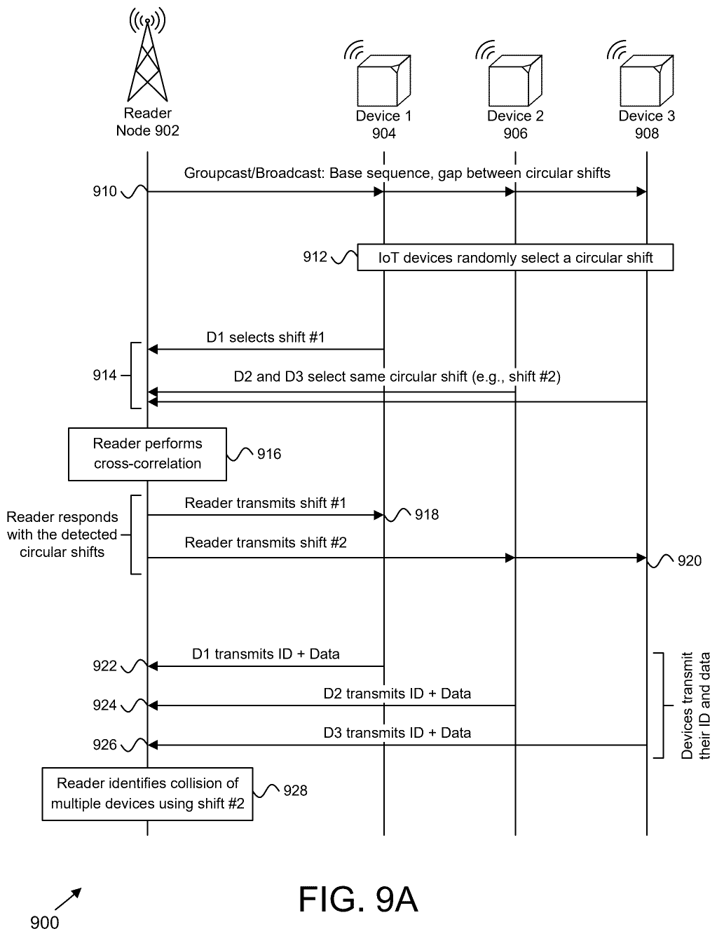

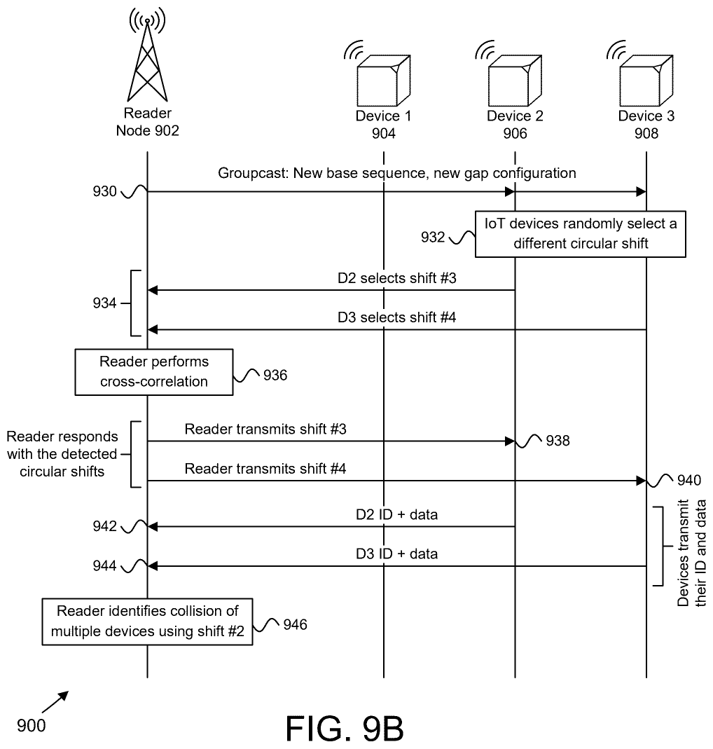

FIG. 9A-9B shows an exemplary message flow for an IoT message procedure 900, in accordance with aspects of present disclosure. The IoT procedure 900 involves a reader node 902, a first IoT device 904 (denoted “D1”), a second IoT device 906 (denoted “D2”), and a third IoT device 908 (denoted “D3”).

Beginning at FIG. 9A, the reader node 902 may send (i.e., using broadcast transmission or groupcast transmission) a first random access configuration comprising at least a base sequence and a gap value for the sequence spacing between different circular shifts of the base sequence (see signaling 910).

The IoT devices 904, 906 and 908 may each randomly select a circular shift (see block 912). For ease of illustration, different time slots are not shown in FIG. 9; however, when the first random access configuration contains TDMA information, it is assumed that the IoT devices 904, 906 and 908 have selected the same time slot for the initial D2R transmission.

The IoT devices 904, 906 and 908 may each perform an initial D2R transmission (e.g., of an initial access message) using the selected circular shift (see signaling 914). In one embodiment, the initial D2R transmission is a response to an inventory command. In the depicted embodiment, the first IoT device 904 selects a first circular shift value (denoted as “shift #1), while the second IoT device 906 and the third IoT device 908 both select a second circular shift value (denoted as “shift #2”).

The reader node 902 may perform cross-correlation on the received D2R signals to detect the different D2R transmissions (see block 916). However, because the second IoT device 906 and the third IoT device 908 both selected the same circular shift value, the reader node 902 may only detect one transmission corresponding to the second circular shift value.

The reader node 902 may respond to the D2R transmissions by transmitting a reply message (e.g., an R2D transmission or DL response message) for each detected circular shift. Accordingly, the reader node 902 may transmit a first reply message that includes (or indicates) the first circular shift value (see signaling 918). Additionally, the reader node 902 may transmit a second reply message that includes (or indicates) the second circular shift value (see signaling 920).

Upon receiving a reply message that includes (or indicated) its selected circular shift, the IoT devices 904, 906 and 908 may transmit their IDs and corresponding data, e.g., using a resource corresponding to the selected circular shift. Accordingly, the first IoT device 904 may transmit a first UL message (e.g., a D2R transmission) that includes its ID and UL data (see signaling 922), the second IoT device 906 may transmit a second UL message (e.g., a D2R transmission) that includes its ID and UL data (see signaling 924), and the third IoT device 908 may transmit a third UL message (e.g., a D2R transmission) that includes its ID and UL data (see signaling 926). As described above, the ID may be the shifted sequence and/or an indication of the selected circular shift value.

The reader node 902 may decode the received UL messages and may identify a collision of multiple IoT devices using the second circular shift value (see block 928). In the depicted embodiment, it is assumed that the second IoT device 906 and the third IoT device 908 both selected the same circular shift value. Accordingly, the second IoT device 906 and the third IoT device 908 may each transmit their respective UL message using the same resource, thereby resulting in the collision.

Continuing on FIG. 9B, the reader node 902 may transmit (i.e., using groupcast transmission) a second random access configuration to the collided devices (see signaling 910). Here, the collided devices may be the second IoT device 906 and the third IoT device 908. In the depicted embodiment, the second random access configuration may indicate (or may include) a new base sequence and/or a new gap value for the sequence spacing between different circular shifts of the base sequence.

The IoT devices 906 and 908 may each randomly select a different circular shift (see block 932), and may each perform a D2R transmission (e.g., a retransmission of the initial access message) using the reselected circular shifts (see signaling 934). In one embodiment, this D2R transmission may be a retransmission of the response to the inventory command. In the depicted embodiment, the second IoT device 906 may select a third circular shift value (denoted as “shift #3), while the third IoT device 908 may select a fourth circular shift value (denoted as “shift #4”).

The reader node 902 may perform cross-correlation on the received D2R signals for detecting the different D2R transmissions (see block 936). In the depicted embodiment, it is assumed that the second IoT device 906 and the third IoT device 908 selected different circular shift values, and thus the reader node 902 detects the different transmissions corresponding to the respective IoT devices.

The reader node 902 may respond to the D2R transmissions by transmitting a reply message (e.g., an R2D transmission) for each detected circular shift. Accordingly, the reader node 902 may transmit a third reply message that includes (or indicates) the third circular shift value (see signaling 938). Additionally, the reader node 902 may transmit a fourth reply message that includes (or indicates) the fourth circular shift value (see signaling 940).

Upon receiving a reply message that includes (or indicated) its reselected circular shift, the IoT devices 906 and 908 may retransmit their IDs and corresponding data, e.g., using a resource corresponding to the reselected circular shift. Accordingly, the second IoT device 906 may retransmit the third UL message (e.g., a D2R transmission) that includes its ID and UL data (see signaling 942), and the third IoT device 908 may retransmit the third UL message (e.g., a D2R transmission) that includes its ID and UL data (see signaling 944).

The reader node 902 may decode the received UL messages and may identify a collision of multiple IoT devices using the second circular shift value (see block 946). In the depicted embodiment, it is assumed that the second IoT device 906 and the third IoT device 908 selected different circular shift values after receiving the second random access configuration, and thus there is no collision as these devices transmit their respective UL message using the different resources.

In certain implementations, a respective reader node may select the base sequence, its length, and/or the gap/circular shift spacing between different circular shifts of the base sequence based on the expected number of IoT devices to be inventoried during a certain inventory round.

In another implementation, the first random access configuration may include (or indicate) more than one gap value (e.g., sequence spacing) and/or more than one minimum shift (e.g., circular shift offset) that may be selected by a receptive IoT device, where each gap value and minimum shift is used for a certain device type. For example, the reader node may indicate that a first type of IoT device (e.g., devices having no energy storage and no independent signal generation) is to use a gap value of 10 starting from 0 shift, such that devices of this first type may select a circular shift value of 0, 10, 20, 30, etc., while a second type of IoT device (e.g., having energy storage and/or having independent signal generation) is to use a gap value of 10 starting from 5 shift, such that devices of this second type may select a circular shift value between 5, 15, 25, 35, etc. Accordingly, the reader node may use the detected circular shift for identifying the responding devices, as well as identifying the types of the responding devices.

In another implementation, the reader node (such as a BS) may assign different base sequences, each to be used by a certain group of IoT devices. In yet another implementation, the mechanism for randomly selecting time slots by different devices may be based on different device types. For example, an IoT devices of a first type may be configured to choose its time slot among odd slots, and another IoT device of a second type may be configured to choose its time slot among even slots, so that the reader node knows that the CDMed devices transmitting in a certain time slot are of the same IoT device type.

In alternative embodiment, the code domain information in a respective random access configuration may include an indication for randomly selecting one row from a pre-configured orthogonal matrix, e.g., Hadamard matrix, for their UL transmission of random access. As understood in the art, a Hadamard matrix is a square matrix whose entries are either +1 or −1, and its rows are mutually orthogonal to one another. For example, the IoT device may store one or more Hadamard matrices in memory, and the random access configuration may indicate that the IoT device is to select (e.g., at random) a row from a stored Hadamard matrix. Since the rows of the Hadamard matrix are mutually orthogonal, when different IoT devices transmit their signals modulated with different rows of the Hadamard matrix, the signals will be orthogonal to each other.

According to aspects of a third solution, the reader node may implement energy-aware scheduling of IoT devices when performing an IoT communication procedure, such as an inventory procedure. Because the received power for RF harvesting depends on the distance of the IoT device from the emitter/reader, the outage probability of an AIoT devices is affected by the received power for various capacitance sizes.

Accordingly, an AIoT device with low received power may need to be scheduled earlier to operate sustainably without any outage probability. However, the slotted Aloha scheme of randomly scheduling the devices in an inventory round does not take into consideration the received power nor the available energy at the capacitor. Therefore, to minimize the outage probability, the scheduling of such AIoT devices may be sorted according to the received power or the available energy at the capacitor (e.g., determined by device type), or both. Such mechanism also relaxes the minimum required capacitance size (for example, from 15 μF to 5 μF) to sustainably operate the device without outage.

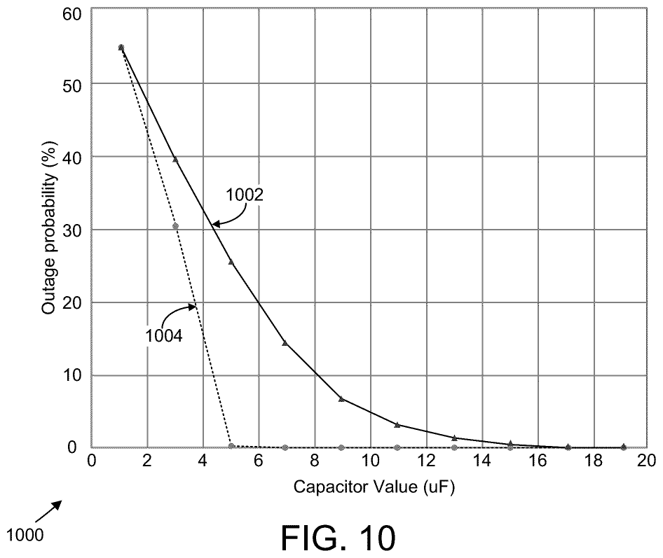

FIG. 10 shows a chart 1000 comparing the outage probability between the random slotted Aloha scheme and the energy-aware scheduling for AIoT devices, in accordance with aspects of the present disclosure. The chart 1000 includes a first graph 1002 of performance of the slotted Aloha scheme, and a second graph 1004 of performance of the energy-aware scheduling. As depicted, the energy-aware scheduling may achieve the same outage probability using smaller capacitor values than the slotted Aloha scheme.

In some embodiments, the energy-aware scheduling the AIoT devices may be implemented based on condition-based access, where the condition-based access criteria may sort the AIoT device according to the received power from the emitter or the available energy at the capacitor, or both.

However, more devices satisfying the condition may try transmitting the RACH message to the network, thereby resulting in more collisions. To minimize the likelihood of a collision, the resources may be configured in the trigger as in the combination of time-division multiplexing (TDM), frequency-division multiplexing (FDM), and CDM.

In certain embodiments, the condition-based access may involve the periodic transmission of a RACH occasion trigger, such as a query-rep message. As user herein, “query-rep” is a command name in an RFID procedure. For example, a RACH transmission round transmitted within the inventory round may signal one or more threshold values and these threshold values may be in terms of threshold ranges for sub-selecting the population of devices to access the reader/network. Such threshold values may be defined in terms of received power at the AIoT devices, an available energy at the capacitor of an AIoT device, or a sustainable operation time of the AIoT device, or some combination thereof. Those AIoT devices fulfilling the threshold values (e.g., as a condition for accessing the network or reader) may transmit the random access message in one or more pre-configured periodic RACH occasions.

In certain embodiments, the condition-based access according to the periodic transmission of a trigger message within an inventory round, may activate set of configured grant (CG) resource type 1 or CG resource type 2 of RACH occasions within the RACH round so that the AIoT device fulfilling the condition may select a CG resource for the transmission of RACH message.

In certain embodiments, a respective AIoT device may prioritize the selection of resources in terms of time domain, frequency domain, and then the code domain. In other embodiments, the AIoT device may prioritize the selection of resources in another combination of the time domain, the frequency domain, and the code domain or in combination thereof. Accordingly, the AIoT device may first select time domain resources within a duration of the RACH round and if the AIoT device does not receive any contention resolution message within the end of the RACH round, then the AIoT device may select another FDM resource or a different circular shifts generated by a gap value/shift value in the second round and so on.

In some embodiment, an IoT device (e.g., AIoT device) having sufficient sustainable operation time may repeatedly transmit the same payload in multiple time domain or frequency domain or code domain resources (or a combination thereof) to increase the diversity of access to the network. In certain embodiments, the network may configure the number of repetitions allowed to control the likelihood of collision due to congestion. For example, the IoT device may perform a first transmission using a first circular shift value in a first time domain resource and may perform a second transmission using a second circular shift value in a second time domain resource, using the transmission diversity for increasing the likelihood of access.

In certain embodiments, the IoT device may transmit in a second occasion only after expiry of timer due to non-reception of the contention resolution message. In certain embodiments, the selection of different circular shift in different occasions may further consider the selection of different gap values to the circular shifts or select a gap value from different set of interval of allowed circular shift values.

An AIoT device may autonomously select the uplink resource (i.e., D2R resource) in the time slot or the occasion in the time domain or the code domain, or a combination thereof, for transmission according to its sustainable operation time. In certain embodiments, an IoT device may consider the packet delay budget when selecting the resource for transmission. However, in case of AIoT, the sustainable operation time may be another metric for selecting the resource for transmission.

For example, an AIoT device may select the uplink resource (i.e., D2R resource) at an interval between when the trigger was sent, T0, and time T1 which is before the sustainable operation time T2, where T0<T1<T2. Additionally, the AIoT device may enter a sleep mode or an energy harvesting mode when the device's stored energy reaches below an energy threshold for operation. The energy threshold for operation may define when the device can no longer operate sustainably and hence the AIoT device may need to transmit resource within its sustainable operation time.

In some embodiments, the uplink (i.e., D2R) resource occasions may be ordered first based on the frequency domain within a slot, then according to the time domain slots, and then in the code domain. Other combinations of ordering the resource occasion are not precluded.

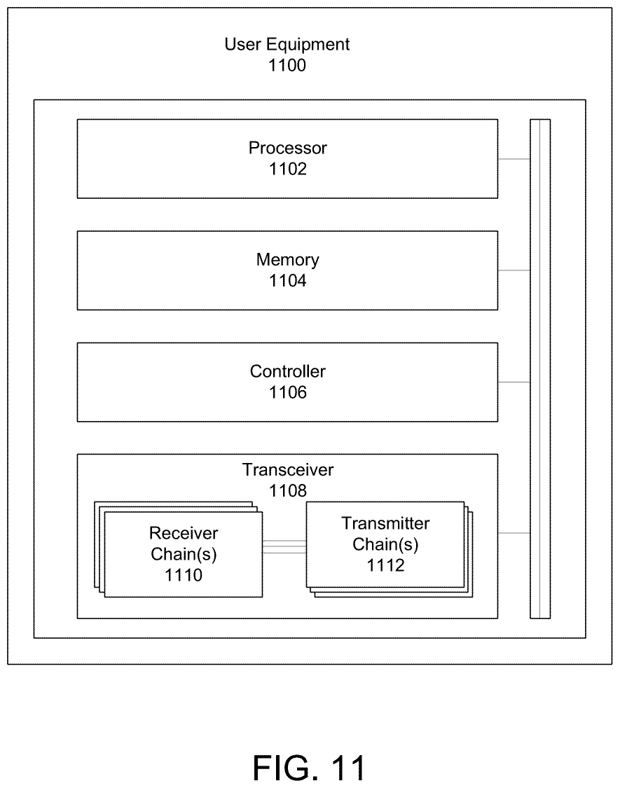

FIG. 11 illustrates an example of a UE 1100 in accordance with aspects of the present disclosure. The UE 1100 may include a processor 1102, a memory 1104, a controller 1106, and a transceiver 1108. The processor 1102, the memory 1104, the controller 1106, or the transceiver 1108, or various combinations thereof or various components thereof may be examples of means for performing various aspects of the present disclosure as described herein. These components may be coupled (e.g., operatively, communicatively, functionally, electronically, electrically) via one or more interfaces.

The processor 1102, the memory 1104, the controller 1106, or the transceiver 1108, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1102 may include an intelligent hardware device (e.g., a general-purpose processor, a DSP, a central processing unit (CPU), an ASIC, a field programmable gate array (FPGA), or any combination thereof). In some implementations, the processor 1102 may be configured to operate the memory 1104. In some other implementations, the memory 1104 may be integrated into the processor 1102. The processor 1102 may be configured to execute computer-readable instructions stored in the memory 1104 to cause the UE 1100 to perform various functions of the present disclosure.

The memory 1104 may include volatile or non-volatile memory. The memory 1104 may store computer-readable, computer-executable code including instructions that, when executed by the processor 1102, cause the UE 1100 to perform various functions described herein. The code may be stored in a non-transitory computer-readable medium such the memory 1104 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1102 and the memory 1104 coupled with the processor 1102 may be configured to cause the UE 1100 to perform one or more of the reader node functions described herein (e.g., executing, by the processor 1102, instructions stored in the memory 1104). Accordingly, the processor 1102 may support wireless communication at the UE 1100 in accordance with examples as disclosed herein.

For example, the UE 1100 may be configured to support a means for transmitting a first random access configuration including code domain information. The UE 1100 may be configured to support a means for receiving a first set of random access transmissions from a set of IoT devices, where each random access transmission of the first set of random access transmissions is multiplexed (e.g., code domain multiplexed) according to the code domain information.

The UE 1100 may be configured to support a means for transmitting a second random access configuration to a subset of IoT devices of the set of IoT devices based at least in part on a collision between a subset of random access transmissions of the first set of random access transmissions, where the subset of random access transmissions is associated with the subset of IoT devices.

The UE 1100 may be configured to support a means for receiving a second set of random access transmissions based on the second random access configuration. In some implementations, the second random access configuration includes an indication to reselect a circular shift for a corresponding random access transmission. In some implementations, the set of IoT devices includes a set of ambient power enabled IoT devices (i.e., AIoT devices).

In some implementations, the code domain information includes a base sequence for the first set of random access transmissions. In certain implementations, the base sequence includes a Golay sequence composed of 1s and −1s or a binary sequence composed of 1s and 0s.

In certain implementations, the UE 1100 is configured to A) perform cross correlation between the base sequence and the first set of random access transmissions; B) determine one or more peaks based on the cross correlation, where each peak corresponds to a different circular shift of the base sequence; and C) identify one or more IoT devices of the set of IoT devices based on the one or more peaks.

In certain implementations, the code domain information indicates a gap value for sequence spacing between different circular shifts of the base sequence and a threshold circular shift for the base sequence. In further implementations, the first random access configuration includes information for one or more types of IoT devices, the information including a first gap value and a first threshold shift for a first type of IoT device and a second gap value and a second threshold shift for a second type of IoT device.

In some implementations, the UE 1100 is configured to determine the collision between the subset of random access transmissions associated with the subset of IoT devices. In some implementations, to determine the collision, the UE 1100 is configured to A) identify, from the first set of random access transmissions, a set of one or more shifted sequences; B) transmit, for each shifted sequence, a DL response message (or R2D reply transmission) including an indication of the shifted sequence; and C) receive an undecodable UL transmission (or D2R transmission) corresponding to a same shifted sequence.

In certain implementations, the UE 1100 is configured to receive an UL transmission (or D2R transmission) including UL data and a device identifier. Here, successful reception of UL transmission (or D2R transmission) indicates there was no collision of random access transmissions. In certain implementations, the device identifier includes a shifted sequence associated with a respective IoT device.

In some implementations, the processor 1102 and the memory 1104 coupled with the processor 1102 may be configured to cause the UE 1100 to perform one or more of the IoT functions described herein (e.g., executing, by the processor 1102, instructions stored in the memory 1104). In some implementations, the UE 1100 includes an ambient-power enabled internet-of-things (AIoT) device. Accordingly, the processor 1102 may support wireless communication at the UE 1100 in accordance with examples as disclosed herein.

For example, the UE 1100 may be configured to support a means for receiving a random access configuration including code domain information. The UE 1100 may be configured to support a means for selecting a slot for random access based on the random access configuration.

The UE 1100 may be configured to support a means for selecting a sequence for random access based on the code domain information. The UE 1100 may be configured to support a means for transmitting a random access transmission during the selected slot and according to the selected sequence, where the random access transmission is multiplexed based on the selected sequence.

In some implementations, the code domain information includes a base sequence for the random access transmission, and where the code domain information indicates a gap value for sequence spacing between different circular shifts of the base sequence and a threshold circular shift for the base sequence.

In certain implementations, the base sequence includes a Golay sequence composed of 1s and −1s or a binary sequence composed of 1s and 0s. In certain implementations, to select the sequence, the UE 1100 is configured to apply a circular shift to the base sequence to create a shifted sequence, and where the random access transmission includes the shifted sequence.

In certain implementations, the UE is configured to: A) receive a DL response message (or R2D reply message) including an indication of the shifted sequence; and B) transmit an UL transmission (or D2R transmission) corresponding to the shifted sequence, where the UL transmission includes UL data and a device identifier. In one embodiment, the device identifier is the shifted sequence or a circular shift value corresponding to the shifted sequence.

In some implementations, the UE 1100 is configured to: A) receive a second random access configuration including an indication to reselect a circular shift for a corresponding random access transmission; B) apply a reselected circular shift to a base sequence to create a shifted sequence; and C) transmit a second random access transmission including the shifted sequence, where the second random access transmission is multiplexed based on the shifted sequence.

In some implementations, the code domain information includes an indication for randomly selecting a row of a Hadamard matrix stored in the at least one memory, where the Hadamard matrix includes a square matrix with mutually orthogonal rows, and where to the selected sequence corresponds to a randomly selected row of the Hadamard matrix.

The controller 1106 may manage input and output signals for the UE 1100. The controller 1106 may also manage peripherals not integrated into the UE 1100. In some implementations, the controller 1106 may utilize an operating system (OS) such as iOS®, ANDROID®, WINDOWS®, or other operating systems. In some implementations, the controller 1106 may be implemented as part of the processor 1102.

In some implementations, the UE 1100 may include at least one transceiver 1108. In some other implementations, the UE 1100 may have more than one transceiver 1108. The transceiver 1108 may represent a wireless transceiver. The transceiver 1108 may include one or more receiver chains 1110, one or more transmitter chains 1112, or a combination thereof.

A receiver chain 1110 may be configured to receive signals (e.g., control information, data, packets) over a wireless medium. For example, the receiver chain 1110 may include one or more antennas for receiving the signal over the air or wireless medium. The receiver chain 1110 may include at least one amplifier (e.g., a low-noise amplifier (LNA)) configured to amplify the received signal. The receiver chain 1110 may include at least one demodulator configured to demodulate the received signal and obtain the transmitted data by reversing the modulation technique applied during transmission of the signal. The receiver chain 1110 may include at least one decoder for decoding/processing the demodulated signal to receive the transmitted data.

A transmitter chain 1112 may be configured to generate and transmit signals (e.g., control information, data, packets). The transmitter chain 1112 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1112 may also include at least one power amplifier configured to amplify the modulated signal to an appropriate power level suitable for transmission over the wireless medium. The transmitter chain 1112 may also include one or more antennas for transmitting the amplified signal into the air or wireless medium.

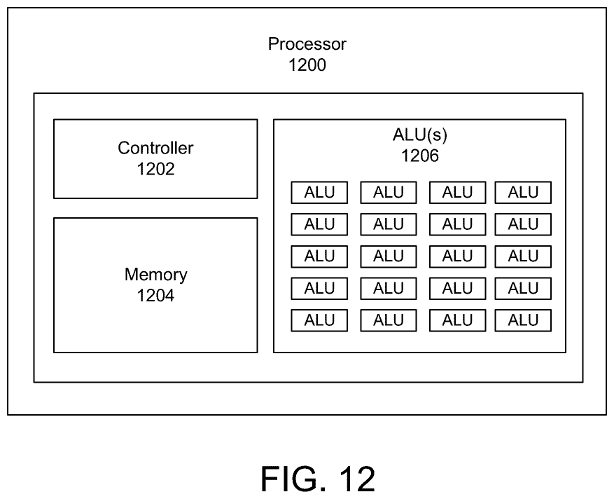

FIG. 12 illustrates an example of a processor 1200 in accordance with aspects of the present disclosure. The processor 1200 may be an example of a processor configured to perform various operations in accordance with examples as described herein. The processor 1200 may include a controller 1202 configured to perform various operations in accordance with examples as described herein. The processor 1200 may optionally include at least one memory 1204, which may be, for example, an L1/L2/L3 cache. Additionally, or alternatively, the processor 1200 may optionally include one or more arithmetic-logic units (ALUs) 1206. One or more of these components may be in electronic communication or otherwise coupled (e.g., operatively, communicatively, functionally, electronically, electrically) via one or more interfaces (e.g., buses).

The processor 1200 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1200) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1202 may be configured to manage and coordinate various operations (e.g., signaling, receiving, obtaining, retrieving, transmitting, outputting, forwarding, storing, determining, identifying, accessing, writing, reading) of the processor 1200 to cause the processor 1200 to support various operations in accordance with examples as described herein. For example, the controller 1202 may operate as a control unit of the processor 1200, generating control signals that manage the operation of various components of the processor 1200. These control signals include enabling or disabling functional units, selecting data paths, initiating memory access, and coordinating timing of operations.

The controller 1202 may be configured to fetch (e.g., obtain, retrieve, receive) instructions from the memory 1204 and determine subsequent instruction(s) to be executed to cause the processor 1200 to support various operations in accordance with examples as described herein. The controller 1202 may be configured to track memory address of instructions associated with the memory 1204. The controller 1202 may be configured to decode instructions to determine the operation to be performed and the operands involved. For example, the controller 1202 may be configured to interpret the instruction and determine control signals to be output to other components of the processor 1200 to cause the processor 1200 to support various operations in accordance with examples as described herein. Additionally, or alternatively, the controller 1202 may be configured to manage flow of data within the processor 1200. The controller 1202 may be configured to control transfer of data between registers, arithmetic logic units (ALUs), and other functional units of the processor 1200.

The memory 1204 may include one or more caches (e.g., memory local to or included in the processor 1200 or other memory, such RAM, ROM, DRAM, SDRAM, SRAM, MRAM, flash memory, etc. In some implementations, the memory 1204 may reside within or on a processor chipset (e.g., local to the processor 1200). In some other implementations, the memory 1204 may reside external to the processor chipset (e.g., remote to the processor 1200).

The memory 1204 may store computer-readable, computer-executable code including instructions that, when executed by the processor 1200, cause the processor 1200 to perform various functions described herein. The code may be stored in a non-transitory computer-readable medium such as system memory or another type of memory. The controller 1202 and/or the processor 1200 may be configured to execute computer-readable instructions stored in the memory 1204 to cause the processor 1200 to perform various functions. For example, the processor 1200 and/or the controller 1202 may be coupled with or to the memory 1204, the processor 1200, the controller 1202, and the memory 1204 may be configured to perform various functions described herein. In some examples, the processor 1200 may include multiple processors and the memory 1204 may include multiple memories. One or more of the multiple processors may be coupled with one or more of the multiple memories, which may, individually or collectively, be configured to perform various functions herein.

The one or more ALUs 1206 may be configured to support various operations in accordance with examples as described herein. In some implementations, the one or more ALUs 1206 may reside within or on a processor chipset (e.g., the processor 1200). In some other implementations, the one or more ALUs 1206 may reside external to the processor chipset (e.g., the processor 1200). One or more ALUs 1206 may perform one or more computations such as addition, subtraction, multiplication, and division on data. For example, one or more ALUs 1206 may receive input operands and an operation code, which determines an operation to be executed. One or more ALUs 1206 be configured with a variety of logical and arithmetic circuits, including adders, subtractors, shifters, and logic gates, to process and manipulate the data according to the operation. Additionally, or alternatively, the one or more ALUs 1206 may support logical operations such as AND, OR, exclusive-OR (XOR), not-OR (NOR), and not-AND (NAND), enabling the one or more ALUs 1206 to handle conditional operations, comparisons, and bitwise operations.

In various implementations, the processor 1200 may support the functions of a node, in accordance with examples as disclosed herein. The node may be referred to as a network node or a wireless node, which may be a network entity, a base station, or a UE as described herein. For example, the processor 1200 may be configured to support a means for transmitting a first random access configuration including code domain information.

The processor 1200 may be configured to support a means for receiving a first set of random access transmissions from a set of IoT devices, where each random access transmission of the first set of random access transmissions is multiplexed (e.g., code domain multiplexed) according to the code domain information.

The processor 1200 may be configured to support a means for transmitting a second random access configuration to a subset of IoT devices of the set of IoT devices based at least in part on a collision between a subset of random access transmissions of the first set of random access transmissions, where the subset of random access transmissions is associated with the subset of IoT devices.

The processor 1200 may be configured to support a means for receiving a second set of random access transmissions based on the second random access configuration. In some implementations, the second random access configuration includes an indication to reselect a circular shift for a corresponding random access transmission. In some implementations, the set of IoT devices includes a set of ambient power enabled IoT devices (i.e., AIoT devices), where the processor 1200 is embodied in a BS, a RAN node, UE, or an intermediate node.

In some implementations, the code domain information includes a base sequence for the first set of random access transmissions. In certain implementations, the base sequence includes a Golay sequence composed of 1s and −1s or a binary sequence composed of 1s and 0s.

In certain implementations, the processor 1200 is configured to A) perform cross correlation between the base sequence and the first set of random access transmissions; B) determine one or more peaks based on the cross correlation, where each peak corresponds to a different circular shift of the base sequence; and C) identify one or more IoT devices of the set of IoT devices based on the one or more peaks.

In certain implementations, the code domain information indicates a gap value for sequence spacing between different circular shifts of the base sequence and a threshold circular shift for the base sequence. In further implementations, the first random access configuration includes information for one or more types of IoT devices, the information including a first gap value and a first threshold shift for a first type of IoT device and a second gap value and a second threshold shift for a second type of IoT device.

In some implementations, the processor 1200 is configured to determine the collision between the subset of random access transmissions associated with the subset of IoT devices. In some implementations, to determine the collision, the processor 1200 is configured to A) identify, from the first set of random access transmissions, a set of one or more shifted sequences; B) transmit, for each shifted sequence, a DL response message (or R2D reply transmission) including an indication of the shifted sequence; and C) receive an undecodable UL transmission (or D2R transmission) corresponding to a same shifted sequence.

In certain implementations, the processor 1200 is configured to receive an UL transmission (or D2R transmission) including UL data and a device identifier. Here, successful reception of UL transmission (or D2R transmission) indicates there was no collision of random access transmissions. In certain implementations, the device identifier includes a shifted sequence associated with a respective IoT device.

In various implementations, the processor 1200 may support the functions of an IoT device, in accordance with examples as disclosed herein. For example, the processor 1200 may be configured to support a means for receiving a random access configuration including code domain information.

The processor 1200 may be configured to support a means for selecting a slot for random access based on the random access configuration. The processor 1200 may be configured to support a means for selecting a sequence for random access based on the code domain information.

The processor 1200 may be configured to support a means for transmitting a random access transmission during the selected slot and according to the selected sequence, where the random access transmission is multiplexed based on the selected sequence.

In some implementations, the code domain information includes a base sequence of the random access transmission, and where the code domain information indicates a gap value for sequence spacing between different circular shifts of the base sequence and a threshold circular shift for the base sequence.

In certain implementations, the base sequence includes a Golay sequence composed of 1s and −1s or a binary sequence composed of 1s and 0s. In certain implementations, to select the sequence, the processor 1200 is configured to apply a circular shift to the base sequence to create a shifted sequence, and where the random access transmission includes the shifted sequence.

In certain implementations, the processor 1200 is configured to: A) receive a DL response message (or R2D reply message) including an indication of the shifted sequence; and B) transmit an UL transmission (or D2R transmission) corresponding to the shifted sequence, where the UL transmission includes UL data and a device identifier. In one embodiment, the device identifier is the shifted sequence or a circular shift value corresponding to the shifted sequence.

In some implementations, the processor 1200 is configured to: A) receive a second random access configuration including an indication to reselect a circular shift for a corresponding random access transmission; B) apply a reselected circular shift to a base sequence to create a shifted sequence; and C) transmit a second random access transmission including the shifted sequence, where the second random access transmission is multiplexed based on the shifted sequence.

In some implementations, the code domain information includes an indication for randomly selecting a row of a Hadamard matrix stored in the at least one memory, where the Hadamard matrix includes a square matrix with mutually orthogonal rows, and where to the selected sequence corresponds to a randomly selected row of the Hadamard matrix.

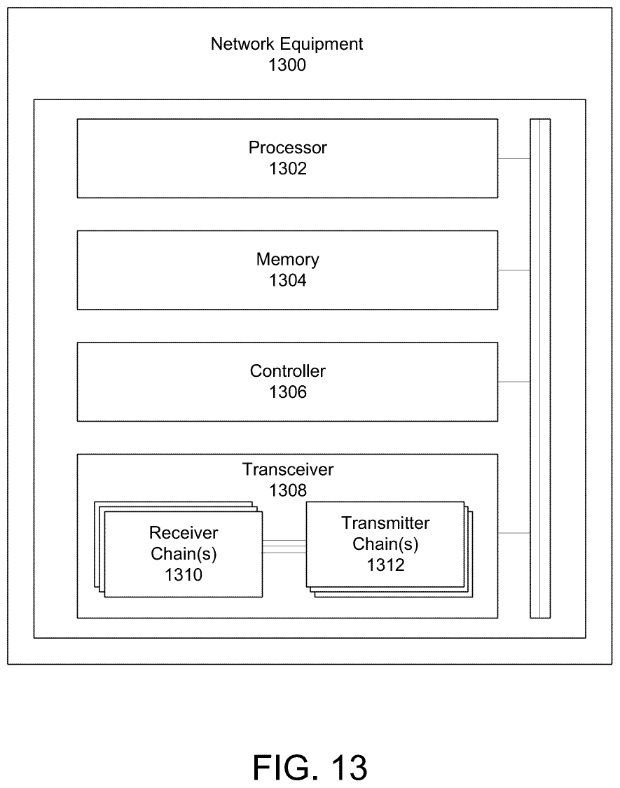

FIG. 13 illustrates an example of an NE 1300 in accordance with aspects of the present disclosure. The NE 1300 may include a processor 1302, a memory 1304, a controller 1306, and a transceiver 1308. The processor 1302, the memory 1304, the controller 1306, or the transceiver 1308, or various combinations thereof or various components thereof may be examples of means for performing various aspects of the present disclosure as described herein. These components may be coupled (e.g., operatively, communicatively, functionally, electronically, electrically) via one or more interfaces.

The processor 1302, the memory 1304, the controller 1306, or the transceiver 1308, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1302 may include an intelligent hardware device (e.g., a general-purpose processor, a DSP, a CPU, an ASIC, an FPGA, or any combination thereof). In some implementations, the processor 1302 may be configured to operate the memory 1304. In some other implementations, the memory 1304 may be integrated into the processor 1302. The processor 1302 may be configured to execute computer-readable instructions stored in the memory 1304 to cause the NE 1300 to perform various functions of the present disclosure.

The memory 1304 may include volatile or non-volatile memory. The memory 1304 may store computer-readable, computer-executable code including instructions when executed by the processor 1302 cause the NE 1300 to perform various functions described herein. The code may be stored in a non-transitory computer-readable medium such the memory 1304 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1302 and the memory 1304 coupled with the processor 1302 may be configured to cause the NE 1300 to perform one or more radio node functions as described herein (e.g., executing, by the processor 1302, instructions stored in the memory 1304). Accordingly, the processor 1302 may support the wireless communication at the NE 1300 in accordance with examples as disclosed herein.

For example, the NE 1300 may be configured to support a means for transmitting a first random access configuration including code domain information. The NE 1300 may be configured to support a means for receiving a first set of random access transmissions from a set of IoT devices, where each random access transmission of the first set of random access transmissions is multiplexed (e.g., code domain multiplexed) according to the code domain information.

The NE 1300 may be configured to support a means for transmitting a second random access configuration to a subset of IoT devices of the set of IoT devices based at least in part on a collision between a subset of random access transmissions of the first set of random access transmissions, where the subset of random access transmissions is associated with the subset of IoT devices.

The NE 1300 may be configured to support a means for receiving a second set of random access transmissions based on the second random access configuration. In some implementations, the second random access configuration includes an indication to reselect a circular shift for a corresponding random access transmission. In some implementations, the set of IoT devices includes a set of ambient power enabled IoT devices (i.e., AIoT devices).

In some implementations, the code domain information includes a base sequence for the first set of random access transmissions. In certain implementations, the base sequence includes a Golay sequence composed of 1s and −1s or a binary sequence composed of 1s and 0s.

In certain implementations, the NE 1300 is configured to A) perform cross correlation between the base sequence and the first set of random access transmissions; B) determine one or more peaks based on the cross correlation, where each peak corresponds to a different circular shift of the base sequence; and C) identify one or more IoT devices of the set of IoT devices based on the one or more peaks.

In certain implementations, the code domain information indicates a gap value for sequence spacing between different circular shifts of the base sequence and a threshold circular shift for the base sequence. In further implementations, the first random access configuration includes information for one or more types of IoT devices, the information including a first gap value and a first threshold shift for a first type of IoT device and a second gap value and a second threshold shift for a second type of IoT device.

In some implementations, the NE 1300 is configured to determine the collision between the subset of random access transmissions associated with the subset of IoT devices. In some implementations, to determine the collision, the NE 1300 is configured to A) identify, from the first set of random access transmissions, a set of one or more shifted sequences; B) transmit, for each shifted sequence, a DL response message (or R2D reply transmission) including an indication of the shifted sequence; and C) receive an undecodable UL transmission (or D2R transmission) corresponding to a same shifted sequence.

In certain implementations, the NE 1300 is configured to receive an UL transmission (or D2R transmission) including UL data and a device identifier. Here, successful reception of UL transmission (or D2R transmission) indicates there was no collision of random access transmissions. In certain implementations, the device identifier includes a shifted sequence associated with a respective IoT device.

The controller 1306 may manage input and output signals for the NE 1300. The controller 1306 may also manage peripherals not integrated into the NE 1300. In some implementations, the controller 1306 may utilize an operating system such as iOS®, ANDROID®, WINDOWS®, or other operating systems. In some implementations, the controller 1306 may be implemented as part of the processor 1302.

In some implementations, the NE 1300 may include at least one transceiver 1308. In some other implementations, the NE 1300 may have more than one transceiver 1308. The transceiver 1308 may represent a wireless transceiver. The transceiver 1308 may include one or more receiver chains 1310, one or more transmitter chains 1312, or a combination thereof.

A receiver chain 1310 may be configured to receive signals (e.g., control information, data, packets) over a wireless medium. For example, the receiver chain 1310 may include one or more antennas for receiving the signal over the air or wireless medium. The receiver chain 1310 may include at least one amplifier (e.g., a low-noise amplifier (LNA)) configured to amplify the received signal. The receiver chain 1310 may include at least one demodulator configured to demodulate the received signal and obtain the transmitted data by reversing the modulation technique applied during transmission of the signal. The receiver chain 1310 may include at least one decoder for decoding/processing the demodulated signal to receive the transmitted data.

A transmitter chain 1312 may be configured to generate and transmit signals (e.g., control information, data, packets). The transmitter chain 1312 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1312 may also include at least one power amplifier configured to amplify the modulated signal to an appropriate power level suitable for transmission over the wireless medium. The transmitter chain 1312 may also include one or more antennas for transmitting the amplified signal into the air or wireless medium.

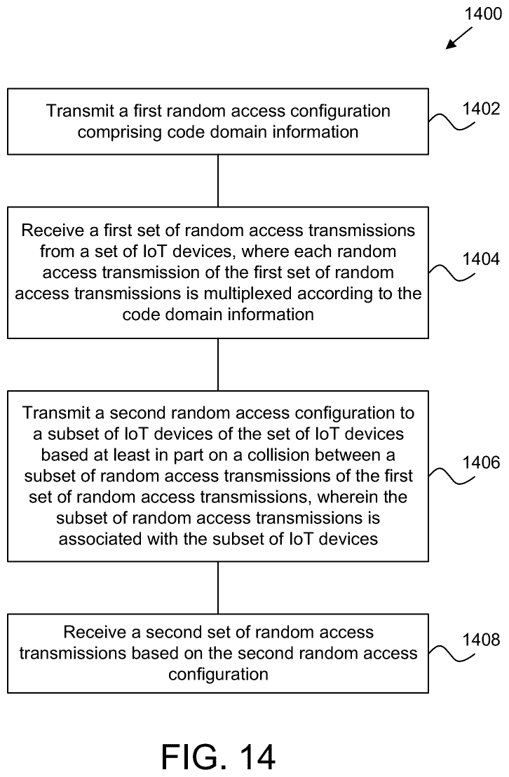

FIG. 14 depicts one embodiment of a method 1400 in accordance with aspects of the present disclosure. In various embodiments, the operations of the method 1400 may be implemented by a node, such as the NE, or a base station, or a UE, as described herein. In some implementations, the NE may execute a set of instructions to control the function elements of the NE to perform the described functions. In other implementations, the UE may execute a set of instructions to control the function elements of the UE to perform the described functions.

At step 1402, the method 1400 may include transmitting a first random access configuration comprising code domain information. The operations of step 1402 may be performed in accordance with examples as described herein. In some implementations, aspects of the operations of step 1402 may be performed by an NE, as described with reference to FIG. 13. In other implementations, aspects of the operations of step 1402 may be performed by a UE, as described with reference to FIG. 11.

At step 1404, the method 1400 may include receiving a first set of random access transmissions from a set of IoT devices, where each random access transmission of the first set of random access transmissions is multiplexed according to the code domain information. The operations of step 1404 may be performed in accordance with examples as described herein. In some implementations, aspects of the operations of step 1404 may be performed by an NE, as described with reference to FIG. 13. In other implementations, aspects of the operations of step 1404 may be performed by a UE, as described with reference to FIG. 11.

At step 1406, the method 1400 may include transmitting a second random access configuration to a subset of IoT devices of the set of IoT devices based at least in part on a collision between a subset of random access transmissions of the first set of random access transmissions, where the subset of random access transmissions is associated with the subset of IoT devices. The operations of step 1406 may be performed in accordance with examples as described herein. In some implementations, aspects of the operations of step 1406 may be performed by an NE, as described with reference to FIG. 13. In other implementations, aspects of the operations of step 1406 may be performed by a UE, as described with reference to FIG. 11.

At step 1408, the method 1400 may include receiving a second set of random access transmissions based on the second random access configuration. The operations of step 1408 may be performed in accordance with examples as described herein. In some implementations, aspects of the operations of step 1408 may be performed by an NE, as described with reference to FIG. 13. In other implementations, aspects of the operations of step 1408 may be performed by a UE, as described with reference to FIG. 11.

It should be noted that the method 1400 described herein describes one possible implementation, and that the operations and the steps may be rearranged or otherwise modified and that other implementations are possible.

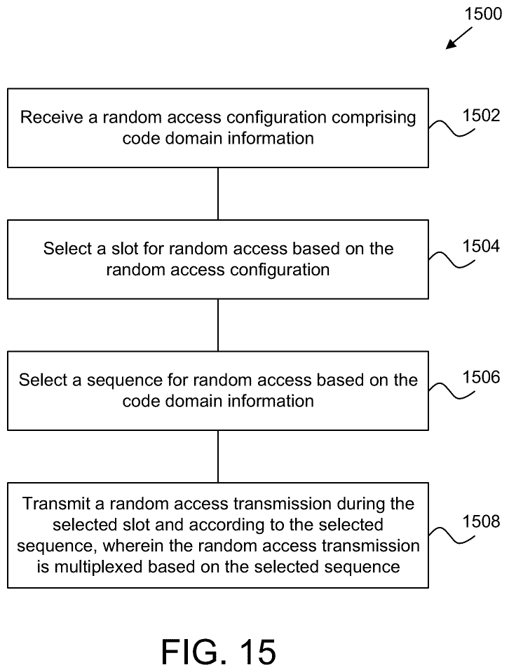

FIG. 15 depicts one embodiment of a method 1500 in accordance with aspects of the present disclosure. In various embodiments, the operations of the method 1500 may be implemented by an IoT device, such as a UE, as described herein. In some implementations, the UE may execute a set of instructions to control the function elements of the UE to perform the described IoT functions.

At step 1502, the method 1500 may include receiving a random access configuration comprising code domain information. The operations of step 1502 may be performed in accordance with examples as described herein. In some implementations, aspects of the operation of step 1502 may be performed by a UE, as described with reference to FIG. 11.

At step 1504, the method 1500 may include selecting a slot for random access based on the random access configuration. The operations of step 1504 may be performed in accordance with examples as described herein. In some implementations, aspects of the operation of step 1504 may be performed by a UE, as described with reference to FIG. 11.

At step 1506, the method 1500 may include selecting a sequence for random access based on the code domain information. The operations of step 1506 may be performed in accordance with examples as described herein. In some implementations, aspects of the operation of step 1506 may be performed by a UE, as described with reference to FIG. 11.

At step 1508, the method 1500 may include transmitting a random access transmission during the selected slot and according to the selected sequence, where the random access transmission is multiplexed based on the selected sequence. The operations of step 1508 may be performed in accordance with examples as described herein. In some implementations, aspects of the operation of step 1508 may be performed by a UE, as described with reference to FIG. 11.

It should be noted that the method 1500 described herein describes one possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A node for wireless communication, comprising:
at least one memory; and
at least one processor coupled with the at least one memory and configured to cause the node to:
transmit a first random access configuration comprising code domain information;
receive a first set of random access transmissions from a set of internet-of-things (IoT) devices, wherein each random access transmission of the first set of random access transmissions is multiplexed according to the code domain information;
transmit a second random access configuration to a subset of IoT devices of the set of IoT devices based at least in part on a collision between a subset of random access transmissions of the first set of random access transmissions, wherein the subset of random access transmissions is associated with the subset of IoT devices; and
receive a second set of random access transmissions based on the second random access configuration.

2. The node of claim 1, wherein the code domain information comprises a base sequence for the first set of random access transmissions.

3. The node of claim 2, wherein the base sequence comprises a Golay sequence composed of 1s and −1s or a binary sequence composed of 1s and 0s.

4. The node of claim 2, wherein the code domain information indicates a gap value for sequence spacing between different circular shifts of the base sequence and a threshold circular shift for the base sequence.

5. The node of claim 4, wherein the first random access configuration comprises information for one or more types of IoT devices, the information comprising a first gap value and a first threshold shift for a first type of IoT device and a second gap value and a second threshold shift for a second type of IoT device.

6. The node of claim 2, wherein the at least one processor is configured to cause the node to:
perform cross correlation between the base sequence and the first set of random access transmissions;
determine one or more peaks based on the cross correlation, wherein each peak corresponds to a different circular shift of the base sequence; and
identify one or more IoT devices of the set of IoT devices based on the one or more peaks.

7. The node of claim 1, wherein the at least one processor is configured to cause the node to:
determine the collision between the subset of random access transmissions associated with the subset of IoT devices.

8. The node of claim 1, wherein, to determine the collision, the at least one processor is configured to cause the node to:
identify, from the first set of random access transmissions, a set of one or more shifted sequences;
transmit, for each shifted sequence, a downlink (DL) message comprising an indication of the shifted sequence; and
receive an undecodable uplink (UL) transmission corresponding to a same shifted sequence.

9. The node of claim 8, wherein the at least one processor is configured to cause the node to receive an UL transmission comprising UL data and a device identifier.

10. The node of claim 1, wherein the second random access configuration comprises an indication to reselect a circular shift for a corresponding random access transmission.

11. The node of claim 1, wherein the set of IoT devices comprises a set of ambient power-enabled internet-of-things (AIoT) devices.

12. A processor for wireless communication, comprising:
at least one controller coupled with at least one memory and configured to cause the processor to:
transmit a first random access configuration comprising code domain information;
receive a first set of random access transmissions from a set of internet-of-things (IoT) devices, wherein each random access transmission of the first set of random access transmissions is multiplexed according to the code domain information;
transmit a second random access configuration to a subset of IoT devices of the set of IoT devices based at least in part on a collision between a subset of random access transmissions of the first set of random access transmissions, wherein the subset of random access transmissions is associated with the subset of IoT devices; and
receive a second set of random access transmissions based on the second random access configuration.

13. An internet-of-things (IoT) device comprising:
at least one memory; and
at least one processor coupled with the at least one memory and configured to cause the IoT device to:
receive a random access configuration comprising code domain information;
select a slot for random access based on the random access configuration;
select a sequence for random access based on the code domain information; and
transmit a random access transmission during the selected slot and according to the selected sequence, wherein the random access transmission is multiplexed based on the selected sequence.

14. The IoT device of claim 13, wherein the code domain information comprises a base sequence of the random access transmission, and wherein the code domain information indicates a gap value for sequence spacing between different circular shifts of the base sequence and a threshold circular shift for the base sequence.

15. The IoT device of claim 14, wherein the base sequence comprises a Golay sequence composed of 1s and −1s or a binary sequence composed of 1s and 0s.

16. The IoT device of claim 14, wherein to select the sequence, the at least one processor is configured to cause the IoT device to apply a circular shift to the base sequence to create a shifted sequence, and wherein the random access transmission comprises the shifted sequence.

17. The IoT device of claim 16, wherein the at least one processor is configured to cause the IoT device to:
receive a downlink (DL) response message comprising an indication of the shifted sequence; and
transmit an uplink (UL) transmission corresponding to the shifted sequence, wherein the UL transmission comprises UL data and a device identifier.

18. The IoT device of claim 13, wherein the at least one processor is configured to cause the IoT device to:
receive a second random access configuration comprising an indication to reselect a circular shift for a corresponding random access transmission;
apply a reselected circular shift to a base sequence to create a shifted sequence; and
transmit a second random access transmission comprising the shifted sequence, wherein the second random access transmission is multiplexed based on the shifted sequence.

19. The IoT device of claim 13, wherein the code domain information comprises an indication for randomly selecting a row of a Hadamard matrix stored in the at least one memory, wherein the Hadamard matrix comprises a square matrix with mutually orthogonal rows, and wherein to the selected sequence corresponds to a randomly selected row of the Hadamard matrix.

20. A processor for wireless communication, comprising:
at least one controller coupled with at least one memory and configured to cause the processor to:
receive a random access configuration comprising code domain information;
select a slot for random access based on the random access configuration;
select a sequence for random access based on the code domain information; and
transmit a random access transmission during the selected slot and according to the selected sequence, wherein the random access transmission is multiplexed based on the selected sequence.
